(19) United States
(12) Patent Application Publication
(10) Pub. No.: US 2008/0254974 A1
(43) Pub. Date: Oct. 16, 2008

(54) SUPPORTED CATALYST FOR FUEL CELL ELECTRODE

(75) Inventors: Yoshihiko Nakano, Yokohama-Shi (JP); Jun Tamura, Yokohama-Shi (JP); Kazuhiro Yasuda, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/050,397

(22) Filed: Mar. 18, 2008

(30) Foreign Application Priority Data
Mar. 26, 2007 (JP) 2007-079123

(51) Int. Cl. B01J 21/06; B01J 23/28; B01J 23/30; B01J 23/22; B01J 21/02

(52) U.S. Cl. 502/202; 502/305; 502/321; 502/353; 502/339; 429/40

(57) ABSTRACT

There is provided a supported catalyst which has an excellent catalyst performance and is stable against highly concentrated methanol. The supported catalyst for a fuel cell electrode comprises a carrier and a catalytic metal supported on the carrier, characterized in that the carrier is hydrophilic and a metal oxide capable of accelerating proton conduction is provided on at least a part of the surface of the hydrophilic carrier.

### CROSS-REFERENCE TO RELATED APPLICATIONS

This application is based upon and claims the benefit of priority from the prior Japanese Patent Application No. 2007-79123, filed on Mar. 26, 2007; the entire contents of which are incorporated herein by reference.

### BACKGROUND OF THE INVENTION

The present invention provides a supported catalyst for a fuel cell for use in the production of electrodes in fuel cells, and an electrode for a fuel cell using the supported catalyst.

Fuel cells electrochemically oxidize a fuel such as hydrogen or methanol within the cell to convert the chemical energy of the fuel directly to electric energy which is then taken out of the cell. Fuel cells have drawn attention as a clean and efficient electric energy supply source because, unlike thermal power generation, there is no generation of NOₓ, SOₓ and the like by the combustion of a fuel. In particular, solid polymer fuel cells unlike other fuel cells can realize a reduction in size and a reduction in weight and thus can be developed as a power supply for space vehicles and have recently been energetically studied as a power supply for automobiles and the like.

A sandwich structure, for example, having a five layer structure of current collector for cathode/cathode/proton conductive film/anode/current collector for anode has been proposed as a conventional electrode structure of fuel cells. In producing such electrodes for fuel cells, that is, anodes and cathodes, what is particularly important is to enhance the prevention of poisoning of an electrode, for example, by carbon monoxide and to enhance the activity per unit catalyst. In order to avoid poisoning and increase the activity, a proposal has been made on a method in which a supporting catalyst metal is selected and is supported as such or as an alloy on a carrier. Up to now, various catalysts for fuel cells and electrodes using the same have been put to practical use.

On the other hand, in catalysts for fuel cells, in general, carbon has hitherto been used as a carrier for supporting the catalyst. The reason for this is that, since carbon is electrically conductive, it is considered that supporting of a catalytic metal directly on carbon is effective for taking out electrons generated on the surface of the catalyst efficiently for contribution to electron conduction.

For example, in a supported catalyst comprising platinum or its alloy supported in a high concentration on carbon, however, there is a danger of ignition upon contact with an organic solvent (particularly alcohol). Further, in the application of a proton conductive material, an alcohol-containing solution should be used from the viewpoint of a problem of the dissolvability. Here again, in the preparation of a slurry for the production of an electrode by the addition of the highly supported carbon catalyst, there is a danger of ignition. In order to eliminate the problem of ignition, a method has been adopted in which water is first added to a catalyst, the mixture is thoroughly stirred to bring the catalyst surface to such a state that the catalyst surface is wetted with water, and a solution containing a proton conductive material dissolved therein is added to prepare a slurry.

These carbon supported catalysts, however, are hydrophobic and thus suffer from the following additional problem. Specifically, when water is added to the carbon supported catalyst followed by stirring, catalysts are aggregated and, consequently, the proton conductive material which are subsequently added cannot be dispersed evenly over the whole catalyst. Accordingly, the proportion of a part where a three layer interface necessary for forming a fuel cell is not formed is unavoidably increased resulting in deteriorated utilization ratio of the catalyst. Further, a polymer electrolyte as the above proton conductive material used in the conventional electrode is likely to dissolve upon exposure to a liquid fuel such as methanol, leading to a problem of durability.

### BRIEF SUMMARY OF THE INVENTION

The present invention is directed to improve the utilization ratio of the catalyst and, at the same time, to provide a supported catalyst having excellent insolubility in and stability against liquid fuels. Further, the present invention includes an electrode, an membrane electrode assembly and a fuel cell using the supported catalyst.

A supported catalyst for a fuel cell electrode according to the present invention comprises a carrier and a catalytic metal supported on the carrier, the carrier comprising hydrophilic metal oxide A, and metal oxide B being supported on at least a part of the surface of said carrier to impart proton conductivity to the supported catalyst.

According to another aspect of the present invention, there is provided a process for producing the above-mentioned supported catalyst comprising: supporting a metal salt as a precursor of a catalytic metal on a carrier comprising a hydrophilic metal oxide A to prepare a first composite; subjecting the first composite to reduction treatment to support the resultant catalytic metal onto a surface of the carrier to obtain a second composite; supporting a precursor of a metal oxide B onto the second composite to obtain a third composite; and subjecting the third composite to heat decomposition treatment to produce a supported catalyst having proton conductivity.

In the supported catalyst according to the present invention, both a catalyst component and a metal oxide for enhancing proton conductivity are supported so as to be copresent on a hydrophilic carrier. Accordingly, the supported catalyst has excellent catalyst performance and is very stable against highly concentrated methanol and thus is very advantageous in that the reliability of the fuel cell in which a highly concentrated fuel is used can be further improved.

### BRIEF DESCRIPTION OF THE DRAWING

FIG. 1 is a cross-sectional view showing the construction of a principal part of a fuel cell in one embodiment of the present invention.

### DETAILED DESCRIPTION OF THE INVENTION

### Supported Catalyst

As described above, the supported catalyst for a fuel cell electrode comprises: a carrier and a catalytic metal supported on the carrier, characterized in that the carrier is hydrophilic metal oxide A, and metal oxide B is further supported on at least a part of the surface of the carrier to impart proton conductivity to the supported catalyst.

In the present invention, a hydrophilic material is used as a carrier (support material) for supporting a catalyst component. The hydrophilic carrier (metal oxide A) may be an oxide of titanium represented by TiOₓ or zirconia oxide represented by ZrOₓ. In particular, titanium oxide (TiO₂) or ZrO₂ is preferred. The average particle diameter of the carrier is preferably not more than 500 nm. The specific surface area (specific surface area as measured by BET method) is preferably in the range of 10 to 2500 mm²/g, particularly preferably in the range of 50 to 1000 mm²/g. When the specific surface area is less than 10 mm²/g, the amount of the catalyst supported is disadvantageously reduced, while, when the specific surface area exceeds 2500 mm²/g, disadvantageously, the difficulty of synthesis per se is likely to be increased.

In the present invention, a proton conductive metal oxide is supported by supporting a catalytic metal on the surface of the above carrier and further compositing the catalytic metal with at least a part of the carrier surface.

The catalytic metal to be supported is preferably a platinum particle or a particle of an alloy of at least one metal, selected from platinum group elements and fourth to sixth period transition metals, with platinum. Platinum group elements include, but are not limited to, platinum (Pt), ruthenium (Ru), rhodium (Rh), iridium (Ir), osmium (Os), and palladium (Pd). Specific preferred platinum group elements include Pt, Pt—Ru, Pt—Ru—Ir, Pt—Ru—Ir—Os, Pt—Ir, Pt—Mo, Pt—Ru—Mo, Pt—Fe, Pt—Co, Pt—Ni, Pt—Ru—Ni, Pt—W, Pt—Ru—W, Pt—Sn, Pt—Ru—Sn, Pt—Ce, and Pt—Re.

In the present invention, in addition to the above catalyst component, metal oxide B having proton conductivity imparted by supporting onto the carrier is supported on at least a part of the surface of the carrier. This metal oxide B is preferably an oxide containing at least one element selected from the group consisting of tungsten (W), molybdenum (Mo), vanadium (V), and boron (B). In particular, the metal oxide is preferably a solid oxide superstrong acid having a Hammett acidity function H₀ in the range of −20.00<H₀<−11.93 from the viewpoint of promoting the proton conduction.

The content of metal oxide B is preferably in the range of 0.1 to 20% by weight, particularly preferably 0.5 to 10% by weight, based on the weight of the supported catalyst. When the content of the metal oxide is less than 0.1% by weight, the proton conductivity is unsatisfactory. On the other hand, when the addition amount of the metal oxide exceeds 20% by weight, disadvantageously, the metal oxide is present at sites other than the carrier and the catalyst performance is deteriorated.

In the conventional supported catalyst for a fuel cell, it is common practice to use carbon as a carrier. The carbon carrier has both a function as a support (a carrier) for a catalyst and a function of an electroconductive path. On the other hand, in the present invention, the above construction was adopted to separate the two functions and, further, to impart good proton conductivity to the catalyst.

Specifically, a hydrophilic material is selected as a carrier, and a superstrongly acidic metal oxide having proton conductivity is supported in a layer and/or particulate form on the surface of the hydrophilic carrier. Further, in order to impart a function as an electroconductive path, an electroconductive material has been added to ensure electroconductive properties. In the present invention, by virtue of the function separation, both the prevention of ignition and the improvement of the dispersion of the catalyst, which have been problems in the prior art, can be effectively realized. Specifically, in order to prevent ignition caused by the use of the organic solvent, preferably, water is first added followed by slurrying. The production of a catalyst using the conventional carbon carrier has a problem that, due to hydrophobicity of carbon, the dispersibility is deteriorated. In the present invention, the dispersibility can be significantly improved by using the hydrophilic carrier. Further, in the present invention, since the catalyst and the proton conductive material are present on an identical catalyst carrier, the reactive interface can effectively be utilized and can advantageously comprehensively improve the catalyst properties.

Next, a preferred embodiment of the production process of the supported catalyst according to the present invention will be described.

The process for producing the supported catalyst comprises supporting a metal salt as a precursor of a catalytic metal on a carrier comprising a hydrophilic metal oxide A to prepare a first composite, subjecting the first composite to reduction treatment to support the resultant catalytic metal onto a surface of the carrier to obtain a second composite, supporting a precursor of a metal oxide B onto the second composite to obtain a third composite, and subjecting the third composite to heat decomposition treatment to produce a supported catalyst having proton conductivity.

In a preferred embodiment of the production process, the hydrophilic carrier material (metal oxide A) such as TiOₓ (or ZrOₓ) is first suspended in water. The suspension is heated, and metal salts as a precursor of the catalytic metal particles are added. Further, an alkali is added thereto to give a neutral or weakly alkaline suspension which is properly continuously heated. Thereafter, the mixture is filtered, and the precipitate is then washed. The washed precipitate is placed in a flask, and pure water is added followed by heating. After the elapse of a given period of time, the mixture is filtered, and the precipitate is washed.

The precipitate thus obtained is dried in a drier. The dried precipitate is placed in an atmosphere furnace, and heat reduction is carried out while allowing a hydrogen-containing gas to flow into the furnace. Regarding the furnace temperature, an optimal temperature range may be properly selected according to the material system used. In general, however, the furnace temperature is preferably 100° C. to 900° C., particularly preferably 200° C. to 500° C. In general, when the furnace temperature is below 100° C., the reduction of the catalyst is unsatisfactory. In this case, disadvantageously, when the product is used in an electrode, the particle diameter is likely to increase. On the other hand, when the heating temperature exceeds 900° C., the particle diameter of the produced catalytic metal is likely to increase, disadvantageously leading to an increased probability of a lowering in catalytic activity.

Treatment is carried out for supporting the metal oxide for promoting proton conduction on at least a part of the surface of the carrier. In this case, it is important that the step of supporting the metal oxide be carried out by depositing a precursor of the metal oxide onto the carrier subjected to the step of supporting the catalytic metal by the reduction treatment and subjecting the assembly to heat decomposition treatment. This is because, when the catalytic metal is supported after supporting the metal oxide, the metal oxide for promoting proton conduction is also disadvantageously reduced during the reduction treatment for the catalytic metal.

Preferred precursor compounds of the metal oxide include, but are not limited to, tungstic acid, polytungstic acid, ammonium tungstate, sodium tungstate, ammonium paratungstate, ammonium matatungstate, molybdic acid, polymolybdic acid, ammonium molybdate, ammonium paramolybdate, ammonium metabutenate, sodium molybdate, ammonium vanadate, ammonium orthovanadate, ammonium metavanadate, polyvanadic acid, boric acid, metaboric acid, polyboric acid, ammonium polyborate, and sodium borate.

The present invention includes an electrode for a fuel cell, comprising the above supported catalyst, a membrane electrode assembly comprising the electrode, and a fuel cell comprising the membrane electrode assembly. Embodiments of them will be described.

### Electrode for Fuel Cell and Membrane Electrode Composite

At the outset, a process for producing an electrode for a fuel cell by adding an electroconductive material and a binder to provide electroconductive properties for constructing an electrode using the supported catalyst will be described.

The electroconductive material is preferably at least one material selected from the group consisting of carbon particles, CNF, CNT, and carbon particles, CNF and CNT on which a redox catalyst has been supported. The weight ratio between the electroconductive material and the catalytic metal is preferably 10 to 1000 parts by weight, particularly preferably 30 to 500 parts by weight, based on 100 parts by weight of the catalyst. When the amount of the electroconductive material is less than 10 parts by weight, the electroconductivity cannot be satisfactorily ensured. On the other hand, when the addition amount of the electroconductive material exceeds 1000 parts by weight, the catalyst performance is deteriorated and, consequently, disadvantageously, the cell performance is likely to be deteriorated.

Further, a material which can bind the catalytic metal to the electroconductive material can be extensively used as a binder. Specific examples of preferred binders include polymers such as PTFE, PFA, PVA, and NAFION, and inorganic binders which can be prepared by a sol-gel process. The amount of the binder is preferably 0.5 to 100 parts by weight, particularly preferably 1 to 20 parts by weight, based on 100 parts by weight of the catalyst. When the amount of the binder is less than 0.5 part by weight, the electrode layer forming capability is lowered making it difficult to form the electrode. On the other hand, the addition of the binder in an amount of more than 100 parts by weight enhances the resistance, and, consequently, the cell properties are disadvantageously likely to be deteriorated.

Production processes of an electrode for a fuel cell are classified into a wet process and a dry process.

In the production by the wet process, a slurry containing the above composition should be prepared. The slurry is prepared by adding water to the catalyst, stirring the mixture thoroughly, then adding a binder solution (or dispersion liquid), an electroconductive material, and an organic solvent to the stirred liquid, and dispersing the liquid with a dispergator. The organic solvent used generally comprises a single solvent or a mixture of two or more solvents. In the above dispersion, a slurry composition as a dispersion liquid may be prepared with a conventional dispergator (for example, a ball mill, a sound mill, a bead mill, a paint shaker, or a nanomizer).

An electrode may be formed by coating the dispersion liquid (slurry composition) thus prepared onto a current collector (carbon paper or carbon cloth) subjected to water repellent treatment by a proper method and then drying the assembly. In this case, the amount of the solvent in the slurry composition is preferably regulated so that the solid content is 5 to 60% by weight. When the solid content is less than 5% by weight, the coating film is likely to be separated. On the other hand, when the solid content exceeds 600% by weight, the coating step per se is difficult. The degree of the water repellent treatment of the carbon paper and carbon cloth may be properly regulated so that the slurry composition can be coated.

Next, the production process of an electrode by suction filtration will be described. At the outset, the above supported catalyst and electroconductive material are dispersed, and suction is carried out using the carbon paper or carbon cloth in the current collector part as a filter paper to form a deposit layer formed of the catalyst and the electroconductive material. The assembly is dried, and a binder solution (a dispersion liquid) is impregnated into the dried deposit layer by a vacuum impregnation method, followed by drying to form an electrode. In this case, heat may be added to improve the binding property of the binder.

A method may also be used in which a catalyst composition containing a predetermined pore forming agent is immersed in an aqueous acid or alkaline solution to dissolve the pore forming agent, and washing with ion exchanged water is conducted followed by drying to prepare an electrode. In particular, when a method is adopted in which the catalyst composition is immersed in an alkaline solution to dissolve the pore forming agent, after washing with an acid, washing with ion exchanged water is carried out followed by drying to prepare an electrode.

A membrane electrode composite may be prepared by holding a proton conductive solid film between the electrodes prepared above and thermocompression bonding the assembly by a roll press. Specifically, in the supported catalyst according to the present invention, a Pt—Ru highly resistant to methanol and carbon monoxide is used as a catalytic metal in the anode electrode catalyst. On the other hand, an electrode using platinum as a catalytic metal is used in the cathode electrode. The membrane electrode composite may be constructed using these electrodes.

In the production of the membrane electrode composite, the thermocompression bonding is carried out under conditions of temperature 100° C. to 180° C., pressure 10 to 200 kg/cm², and compression bonding time not less than 1 min and not more than 30 min. Under such conditions that the pressure is low (less than 10 kg/cm²), the temperature is low (below 100° C.), and the compression bonding time is short (less than 1 min), the following unfavorable results occur: the compression bonding is unsatisfactory, and the resistance is increased, often leading to deteriorated cell properties. On the other hand, under conditions of high temperature, high pressure, and long compression bonding time, the deformation of the solid film, the decomposition, and the deformation of the current collector are significant. As a result, the fuel and the oxidizing agent are not supplied well, and the film is likely to be broken, often resulting in deteriorated cell properties.

On the other hand, a catalyst layer coated proton conductive film may be formed by coating the above slurry composition directly onto a proton conductive film or by coating the above slurry composition on a transfer film and drying the coating to form a catalyst layer and then transferring the catalyst layer onto the proton conductive film. In this method, a composite (CCM) comprising an anode catalyst layer and a cathode catalyst layer provided on both sides of the proton conductive film can be prepared. MEA may also be prepared by disposing a current collector for a cathode (a carbon paper or a carbon cloth) on the cathode side of CCM and a current collector for an anode on the anode side, and compressing the assembly for form a composite. The compression is preferably carried out under conditions of room temperature to 180° C., pressure 10 to 200 kg/cm², and compression bonding time not less than 1 min and not more than 30 min. Under such conditions that the pressure is low (less than 10 kg/cm²), the temperature is low (below 100° C.), and the compression bonding time is short (less than 1 min), the following unfavorable results occur: the compression bonding is unsatisfactory, and the resistance is increased, often leading to deteriorated cell properties. On the other hand, under conditions of high temperature, high pressure, and long compression bonding time, the deformation of the solid film, the decomposition, and the deformation of the current collector are significant. As a result, the fuel and the oxidizing agent are not supplied well, and the film is likely to be broken, often resulting in deteriorated cell properties.

### Fuel Cell

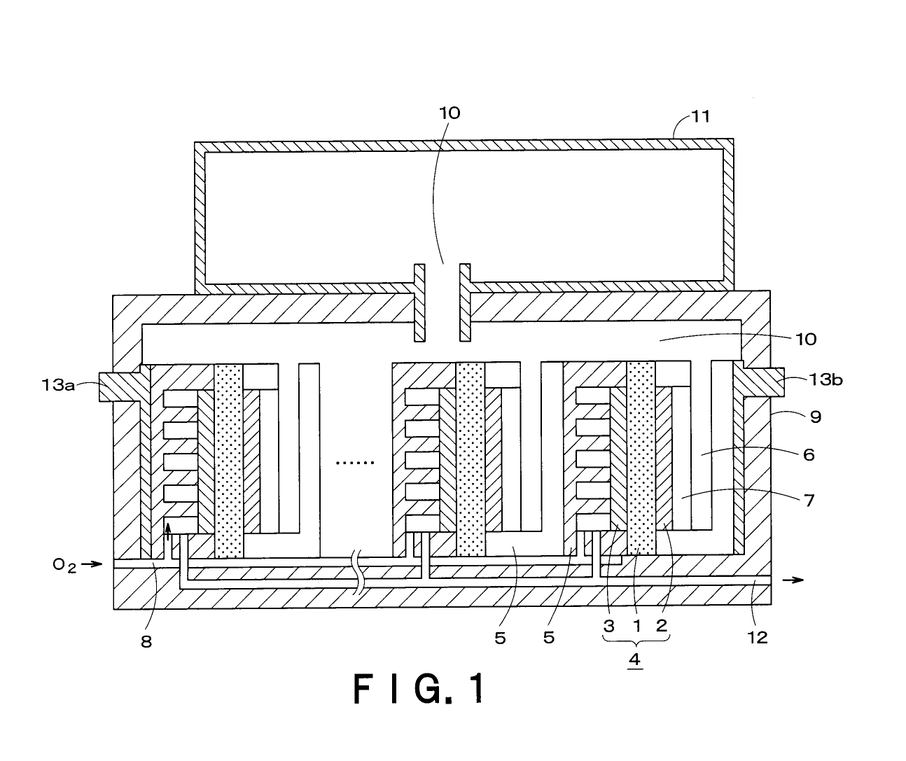

A methanol fuel cell shown in FIG. 1 is an embodiment of the construction of a full cell using the above electrode and membrane electrode composite according to the present invention.

FIG. 1 is a cross-sectional view showing the construction of a principal part of a fuel cell in one embodiment of the present invention. In FIG. 1, numeral 1 designates an electrolyte film held between a fuel electrode (an anode electrode) 2 and an oxidizing agent electrode (a cathode electrode) 3. These electrolyte film 1, fuel electrode 2 and oxidizing agent electrode 3 constitute an electromotive part 4. Here the fuel electrode 2 and the oxidizing agent electrode 3 are formed of an electroconductive porous material so that a fuel and an oxidizing agent gas and, further, electrons are passed therethrough.

In the fuel cell in this embodiment of the present invention, each single cell comprises a fuel penetrating part 6 having the function of holding a liquid fuel fed from a fuel storage tank 11, and a fuel vaporizing part 7 for leading a gas fuel, produced by vaporizing a liquid fuel held in the fuel penetrating part 6 to the fuel electrode 2. A stack 9 as a cell body is constructed by stacking a plurality of single cells, each comprising a fuel penetrating part 6, a fuel vaporizing part 7, and the electromotive part 4, through a separator 5. An oxidizing agent gas feed groove 8 for flowing an oxidizing agent gas is provided as a continuous groove on the separator 5 in its face in contact with the oxidizing agent electrode 3. Reference numeral 12 designates a gas exhaust port. The generated electric power is taken out from power terminals 13 and 13b.

Regarding means for feeding a liquid fuel from a fuel storage tank 11 into a fuel penetrating part 6, for example, a liquid fuel introduction path 10 is provided along at least one side face of a stack 9. The liquid fuel introduced into the liquid fuel introduction path 10 is fed from the side face of the stack 9 into the fuel penetrating part 6, vaporized in the fuel vaporizing part 7, and is fed into a fuel electrode 2. In this case, when the fuel penetrating part is formed of a member which exhibits capillary action, the liquid fuel can be fed into the fuel penetrating part 6 through capillary force without use of any auxiliary device. To this end, a construction which allows the liquid fuel introduced into the liquid fuel introduction path 10 to come into direct contact with the end face of the fuel penetrating part.

When a stack 9 is constructed by stacking single cells as shown in FIG. 1, the separator 5, the fuel penetrating part 6, and the fuel vaporizing part 7 is formed of an electroconductive material so as to function also as a current collection plate for conduction of generated electrons. Further, if necessary, a catalyst layer, for example, in a layer, island, or particulate form is formed between the fuel electrode 2 or the oxidizing agent electrode 3 and the electrolyte film 1. The present invention, however, does not undergo the restriction of the provision of the catalyst layer. Further, the fuel electrode 2 or oxidizing agent electrode 3 per se may be used as a catalyst electrode. The catalyst electrode may have a single structure of the catalyst layer or alternatively may have a multilayer structure comprising a catalyst layer provided on a support such as an electrically conductive paper or a cloth.

As described above, the separator 5 in this embodiment functions also as a channel through which an oxidizing agent gas is allowed to flow. The use of a component 5 having both the function of a separator and the function of a channel (hereinafter referred to as a separator which functions also as a channel) can further reduce the number of components and further reduce the size. Alternatively, a conventional channel can be used instead of the separator 5.

In order to feed a liquid fuel from the fuel storage tank 11 into the liquid fuel introduction path 10, a method may be adopted in which the liquid fuel in the fuel storage tank 11 is naturally dropped and is introduced into the liquid fuel introduction path 10. According to this method, the liquid fuel can be reliably introduced into the liquid fuel introduction path 10 although there is such a structural restriction that the fuel storage tank 11 should be provided at a higher position than the upper face of the stack 9. A method may also be adopted in which the liquid fuel is suctioned from the fuel storage tank 11 through capillary force of a liquid fuel introduction path 10. According to this method, the necessity that the position of the point of connection between the fuel storage tank 11 and the liquid fuel introduction path 10, that is, the position of a fuel inlet provided in the liquid fuel introduction path 10, is provided at a higher position than the upper surface of the stack 9, is eliminated. For example, when this method is used in combination with the above natural dropping method, advantageously, the place of installation of the fuel tank can be freely set.

In this connection, it should be noted that, in order that the liquid fuel introduced into the liquid fuel introduction path 10 through capillary force is continuously fed smoothly into the fuel penetrating part 6 through the capillary force, it is important that the capillary force into the fuel penetrating part 6 be set so as to be larger than the capillary force of the liquid fuel introduction path 10. The number of liquid fuel introduction paths 10 is not limited to one along the side face of the stack 9, and the liquid fuel introduction path 10 can also be formed on the other stack side face.

A construction may be adopted in which the above fuel storage tank 11 is detachable from the cell body. According to this construction, the cell can be continuously operated for a long period of time by replacing the fuel storage tank 11. A construction may also be adopted in which the liquid fuel can be fed from the fuel storage tank 11 into the liquid fuel introduction path 10 by the above natural dropping method or a method in which the liquid fuel is pushed out, for example, by the internal pressure of the tank. Further, a construction may also be adopted in which the fuel is withdrawn through the capillary force of the liquid fuel introduction path 10.

The liquid fuel introduced into the liquid fuel introduction path 10 is then fed into the fuel penetrating part 6 by the above method. The form of the fuel penetrating part 6 is not particularly limited so far as it has the function of holding the liquid fuel in its interior and feeding only the vaporized fuel into the fuel electrode 2 through the fuel vaporizing part 7. For example, the fuel penetrating part 6 may have such a form that a liquid fuel passage is provided and a gas-liquid separating membrane is provided at the interface of the fuel penetrating part 6 and the fuel vaporizing part 7. Further, when a liquid fuel is fed into the fuel penetrating part 6 through capillary force, the form of the fuel penetrating part 6 is not particularly limited so far as a liquid fuel can be penetrated through capillary force. For example, a porous material formed of particles and fillers, nonwoven fabrics manufactured, for example, by a papermaking method, and woven fabrics produced by weaving fibers and, further, narrow spacing formed between plates of glass, plastics or the like.

The use of a porous material as the fuel penetrating part 6 will be explained. At the outset, the capillary force of the porous material as the fuel penetrating part 6 per se may be mentioned as the capillary force. When this capillary force is utilized, the pore diameter is controlled as the so-called interconnected pores formed by connecting pores in the fuel penetrating part 6 as the porous material, and, further, communicated pores continued from the side face of the fuel penetrating part 6 on the liquid fuel introduction path 10 side to at least one face is adopted, whereby the liquid fuel can be fed even in a lateral direction smoothly through capillary force.

The pore diameter and the like of the porous material as the fuel penetrating part 6 is not particularly limited so far as the liquid fuel within the liquid fuel introduction path 10 can be drawn in. Preferably, however, the pore diameter is about 0.01 to 150 μm from the viewpoint of the capillary force of the liquid fuel introduction path 10. The volume of pores as an index of the continuity of pores in the porous material is preferably about 20 to 90%. When the pore diameter is smaller than 0.01 μm, the production of the fuel penetrating part 6 is difficult. On the other hand, when the pore diameter is more than 150 μm, the capillary force is reduced. When the pore volume is less than 20%, the quantity of the interconnected pores is reduced. As a result, the number of closed pores is increased, and, thus, satisfactory capillary force cannot be provided. On the other hand, when the pore volume exceeds 90%, the quantity of interconnected pores is increased. In this case, however, the strength is lowered, and, further, the production of the fuel penetrating part 6 is difficult. The pore diameter and the pore volume are preferably 0.5 to 100 μm and 30 to 75%, respectively, from the practical point of view.

### EXAMPLES

### Example 1

### Production of Cathode Catalyst 1

TiO₂ powder (Super Titania F-6, specific surface area 100 m²/g, manufactured by Showa Denko K.K.) (20 g) was suspended in 1000 ml of water by a homogenizer to give a suspension liquid. The suspension liquid was placed in a three-necked flask provided with a mechanical stirrer, a reflux condenser, and a dropping funnel. The contents of the flask were refluxed for one hr with stirring. Thereafter, 160 ml of an aqueous chloroplatinic acid solution (Pt 42 mg/ml) was added thereto. Twenty min after the addition of the aqueous chloroplatinic acid solution, a solution of 21.0 g of sodium hydrogencarbonate dissolved in 600 ml of water was gradually added dropwise (dropwise addition time: about 60 min).

After the dropwise addition, the mixture was refluxed in this state for 2 hr and was filtered. The resultant precipitate was washed with pure water, was then transferred to a flask, was refluxed in pure water for 2 hr, and was filtered. The resultant precipitate was further washed thoroughly with pure water, and the resultant catalyst was dried in a drier of 100° C.

After drying, the dried catalyst was placed in a high-purity zirconia boat and was reduced in a cylindrical oven at 200° C. for 10 hr while flowing 3% H₂/N₂ gas at a rate of 129 ml, followed by cooling to room temperature to give 24.1 g of a catalyst.

The catalyst (10.0 g) thus obtained was dispersed in 200 ml of water. A separately prepared ammonium tungstate solution was added to the dispersion liquid. The mixture was thoroughly stirred and was then heated to evaporate the solution to dryness and thus to support ammonium tungstate on the catalyst. The resultant precursor was dried at 100° C. for 6 hr and was fired under conditions of 700° C. and 4 hr to heat decompose ammonium tungstate and thus to give a supported catalyst (WO₃/Pt/TiO₂).

The composition ratio of WO₃/TiO₂ in the supported catalyst was 5/95 in terms of weight ratio.

The ammonium tungstate solution was prepared by preparing an aqueous solution of tungsten oxide (WO₃ 0.31 g, manufactured by Wako Pure Chemical Industries, Ltd.) dissolved in an aqueous hot concentrated ammonia solution (15 to 18% aqueous solution, manufactured by Wako Pure Chemical Industries, Ltd.).

### Example 2

### Production of Cathode Catalyst 2

ZrO₂ powder (TZ-O, specific surface area 14 m²/g, manufactured by Tosoh Corporation) (20 g) was suspended in 1000 ml of water by a homogenizer to give a suspension liquid. The suspension liquid was placed in a three-necked flask provided with a mechanical stirrer, a reflux condenser, and a dropping funnel. The contents of the flask were refluxed for one hr with stirring. Thereafter, 160 ml of an aqueous chloroplatinic acid solution (Pt 42 mg/ml) was added thereto. Twenty min after the addition of the aqueous chloroplatinic acid solution, a solution of 21.0 g of sodium hydrogencarbonate dissolved in 600 ml of water was gradually added dropwise (dropwise addition time: about 60 min).

After the dropwise addition, the mixture was refluxed in this state for 2 hr and was filtered. The resultant precipitate was washed with pure water, was then transferred to a flask, was refluxed in pure water for 2 hr, and was filtered. The resultant precipitate was further washed thoroughly with pure water, and the resultant catalyst was dried in a drier of 100° C.

After drying, the dried catalyst was placed in a high-purity zirconia boat and was reduced in a cylindrical oven at 200° C. for 10 hr while flowing 3% H₂/N₂ gas at a rate of 129 ml, followed by cooling to room temperature to give 24.1 g of a catalyst.

The catalyst (10.0 g) thus obtained was dispersed in 200 ml of water. A separately prepared ammonium tungstate solution was added to the dispersion liquid. The mixture was thoroughly stirred and was then heated to evaporate the solution to dryness and thus to support ammonium tungstate on the catalyst. The resultant precursor was dried at 100° C. for 6 hr and was fired under conditions of 700° C. and 4 hr to heat decompose ammonium tungstate and thus to give a supported catalyst (WO₃/Pt/ZrO₂).

The composition ratio of WO₃/ZrO₂ in the supported catalyst was 5/95 in terms of weight ratio.

The ammonium tungstate solution was prepared by preparing an aqueous solution of tungsten oxide (WO₃ 0.31 g, manufactured by Wako Pure Chemical Industries, Ltd.) dissolved in an aqueous hot concentrated ammonia solution (15 to 18% aqueous solution, manufactured by Wako Pure Chemical Industries, Ltd.).

### Comparative Example 1

A supported catalyst was produced in the same manner as in Example 1, except that, in order to support a catalyst, 20 g of carbon black having a specific surface area of 150 m²/g (Printex L, manufactured by Degussa) was used instead of a TiO₂ powder (Super Titania F-6, specific surface area 100 m²/g, manufactured by Showa Denko K.K.) used in Example 1. Further, in taking out the catalyst after the reduction, the catalyst was cooled with dry ice and further subjected to treatment with CO₂ which rendered the catalyst incombustible to produce a catalyst.

### Comparative Example 2

### Production of Supported Catalyst for Anode

A supported catalyst for an anode was produced in the same manner as in Comparative Example 1, except that 80 ml of an aqueous chloroplatinic acid solution and 40 ml of an aqueous ruthenium chloride solution (Ru: 43 mg/ml) were used instead of 160 ml of chloroplatinic acid used in Comparative Example 1.

### Example 3

### Production of Supported Catalyst 1 for Anode

The procedure of Example 1 was repeated, except that 80 ml of an aqueous chloroplatinic acid solution and 40 ml of an aqueous ruthenium chloride solution (Ru: 43 mg/ml) were used instead of 160 ml of chloroplatinic acid used in Example 1.

In the case of the carbon carrier, upon the takeout of the catalyst in the air after the reduction, the carbon carrier is likely to generate heat and ignite as a result of a reaction of hydrogen adsorbed on the catalyst surface with oxygen. As the supporting amount increases, ignition is more likely to occur. Accordingly, a problem of safety occurs. In the supported catalyst of Example 3, since the carrier was incombustible, ignition did not occur.

### Example 4

### Production of Supported Catalyst 2 for Anode

The procedure of Example 1 was repeated, except that 80 ml of an aqueous chloroplatinic acid solution and 40 ml of an aqueous ruthenium chloride solution (Ru: 43 mg/ml) were used instead of 160 ml of chloroplatinic acid used in Example 2.

In the case of the carbon carrier, upon the takeout of the catalyst in the air after the reduction, the carbon carrier is likely to generate heat and ignite as a result of a reaction of hydrogen adsorbed on the catalyst surface with oxygen. As the supporting amount increases, ignition is more likely to occur. Accordingly, a problem of safety occurs. In the supported catalyst of Example 4, since the carrier was incombustible, ignition did not occur.

### Example 5

The catalyst for a cathode (2 g) produced in Example 1, 6 g of pure water, 25 g of zirconia balls having a diameter of 5 mm, and 50 g of balls having a diameter of 10 mm were placed in a 50-ml polymer vessel, and the mixture was thoroughly stirred. Further, 0.2 g of an FEP dispersion liquid (FEP 120J, manufactured by DuPont-Mitsui Fluorochemicals Co., Ltd.), 0.5 g of glycerin, and 7 g of 2-ethoxyethanol were placed in the vessel, and the mixture was thoroughly stirred. Graphite (average particle diameter 3 μm) (1 g) was added thereto, and the mixture was dispersed in a paint shaker for 2 hr to give a slurry composition. The above slurry composition was coated onto a carbon paper subjected to treatment for rendering the paper water repellent (270 μm, manufactured by Toray Industries, Inc.) by a control coater (gap 750 μm), and the coated carbon paper was air dried and was dried at 60° C. for 10 min and at 250° C. for 10 min to produce a cathode electrode 1. The thickness of the catalyst layer was 45 μm.

### Example 6

A cathode electrode 2 was produced in the same manner as in Example 3, except that an aqueous 5% PVA solution was used instead of the FEP dispersion liquid used in Example 5. The thickness of the catalyst layer was 40 μm.

### Example 7

The catalyst for an anode (2 g) produced in Example 3, 7 g of pure water, 25 g of zirconia balls having a diameter of 5 mm, and 50 g of balls having a diameter of 10 mm were placed in a 50-ml polymer vessel, and the mixture was thoroughly stirred. Further, 0.2 g of an FEP dispersion liquid (FEP 120J, manufactured by DuPont-Mitsui Fluorochemicals Co., Ltd.), 0.5 g of glycerin, and 10 g of 2-ethoxyethanol were placed in the vessel, and the mixture was thoroughly stirred. Graphite (average particle diameter 3 μm) (1 g) was added thereto, and the mixture was dispersed in a paint shaker for 2 hr to give a slurry composition. The above slurry composition was coated onto a carbon paper subjected to treatment for rendering the paper water repellent (350 μm, manufactured by Toray Industries, Inc.) by a control coater (gap 900 μm), and the coated carbon paper was air dried and was dried at 60° C. for 10 min and at 250° C. for 10 min to produce a anode electrode 1. The thickness of the catalyst layer was 40 μm.

### Example 8

An anode electrode 2 was produced in the same manner as in Example 5, except that an aqueous 5% PVA solution was used instead of the FEP dispersion liquid used in Example 7. The thickness of the catalyst layer was 43 μm.

### Comparative Example 3

The catalyst for a cathode (1 g) produced in Example 1, 2 g of pure water, 25 g of zirconia balls having a diameter of 5 mm, and 50 g of balls having a diameter of 10 mm were placed in a 50-ml polymer vessel, and the mixture was thoroughly stirred. Further, 4.5 g of 20% Nafion solution, and 10 g of 2-ethoxyethanol were placed in the vessel, and the mixture was thoroughly stirred. Graphite (average particle diameter 3 μm) (1 g) was added thereto, and the mixture was dispersed in a bench-type ball mill for 6 hr to give a slurry composition. The above slurry composition was coated onto a carbon paper subjected to treatment for rendering the paper water repellent (270 μm, manufactured by Toray Industries, Inc.) by a control coater (gap 750 μm), and the coated carbon paper was air dried to produce a cathode electrode 1. The thickness of the catalyst layer was 80 μm.

### Comparative Example 4

An anode electrode was prepared in the same manner as in Comparative Example 3, except that the anode catalyst produced in Comparative Example 2 was used as the catalyst. Further, the above slurry composition was coated onto carbon paper, which had been subjected to treatment for rendering the paper water repellent (350 μm, manufactured by Toray Industries, Inc.), by a control coater (gap 900 μm). The coated carbon paper was air dried to produce a cathode electrode 1. The thickness of the catalyst layer was 100 μm.

### Example 9

A deposit layer of CNF (about 50 μm) was formed on a carbon paper which had been subjected to treatment for rendering the paper water repellent (350 μm, manufactured by Toray Industries, Inc.). The anode catalyst (100 mg) produced in Example 1, 50 mg of carbon black (Printex L, manufactured by Degussa), and 100 g of water were dispersed in each other by a homogenizer to give a liquid which was then deposited on the carbon paper by suction filtration. After drying, a 0.5% aqueous solution of FEP was vacuum impregnated into the carbon paper. Thereafter, the assembly was air dried on a filter paper, followed by drying at 60° C. for 10 min and at 250° C. for 10 min to produce a cathode electrode 3. The thickness of the catalyst layer was about 130 μm.

### Example 10

An anode electrode 3 was produced in the same manner as in Example 9, except that the anode catalyst produced in Example 3 was used.

### Example 11

A cathode electrode 4 was produced in the same manner as in Example 5, except that cathode catalyst 2 produced in Example 2 was used.

### Example 12

An anode electrode 4 was produced in the same manner as in Example 8, except that anode catalyst 2 produced in Example 4 was used.

### Example 13

A test on the dissolution of the electrode in a highly concentrated methanol fuel was carried out.

An eight-day test on the dissolution of the electrodes produced in Examples 5 to 12 and the electrodes produced in Comparative Examples 3 and 4. Specifically, whether or not the electrodes were dissolved in highly concentrated methanol was examined by immersing the electrode in 99.5% methanol at room temperature. The results are shown in Table 1. As shown in Table 1, the electrodes of the present invention were very stable even in the highly concentrated methanol.

TABLE 1
(Results of dissolution test on electrode)

| Electrode | Dissolution test with 99.5% methanol |
|---|---|
| Cathode electrode 1 | Unchanged |
| Cathode electrode 2 | Unchanged |
| Cathode electrode 3 | Unchanged |
| Cathode electrode 4 | Unchanged |
| Anode electrode 1 | Unchanged |
| Anode electrode 2 | Unchanged |
| Anode electrode 3 | Unchanged |
| Anode electrode 4 | Unchanged |
| Comp. Ex. 3 | Catalyst layer fully dissolved in about |
| | 5 min (redispersed in solution) |
| Comp. Ex. 4 | Catalyst layer fully dissolved in about |
| | 5 min (redispersed in solution) |

### Example 14

A plurality of electrodes selected from the cathode electrodes of Examples 5, 6, 9 and 11, the anode electrodes of Examples 7, 8, 10 and 12, the cathode electrode of Comparative Example 3, and the anode electrode of Comparative Example 4 were used in combination for the production of a membrane composite electrode.

Specifically, Nafion 117 was provided as a proton conductive solid polymer film. Various electrodes were cut into a rectangular shape having a size of 3×4 cm to give an electrode area of 12 cm². Nafion 117 was held between the cathode and the anode, followed by thermocompression bonding under conditions of 125° C., 30 min, and 100 kg/cm² to produce a membrane electrode composite (MEA).

Separately, a carbon paper subjected to treatment for rendering the paper water repellent, the cathode electrode composition sheet of Example 9, Nafion 117, the anode electrode composition sheet of Example 10, and a carbon paper subjected to treatment for rendering the paper water repellent were stacked on top of each other in that order, and the assembly was thermocompression bonded under conditions of 125° C., 30 min, and 100 kg/cm² to produce a membrane electrode composite (MEA).

A 1 M methanol solution was fed as a fuel at a flow rate of 0.8 ml/min, and air was fed to the cathode at a flow rate of 120 ml/min to evaluate the fuel cell. The results are shown in Table 2. As a result, it is apparent that the electrodes produced from catalysts to which proton conductivity had been imparted by superstrong acid had performance substantially comparable with a conventional electrode system using NAFION as a proton conductive material.

TABLE 2
(Evaluation of cell performance at 70° C.)

| | | Voltage at current |
|---|---|---|
| | | density of 100 mA/cm² |
| Cathode electrode | Anode electrode | (V) |
| Cathode electrode 1 | Comp. Ex. 4 | 0.47 |
| Cathode electrode 2 | Comp. Ex. 4 | 0.48 |
| Cathode electrode 3 | Comp. Ex. 4 | 0.49 |
| Cathode electrode 4 | Comp. Ex. 4 | 0.47 |
| Comp. Ex. 3 | Anode electrode 1 | 0.48 |
| Comp. Ex. 3 | Anode electrode 2 | 0.47 |
| Comp. Ex. 3 | Anode electrode 3 | 0.48 |
| Comp. Ex. 3 | Anode electrode 4 | 0.475 |
| Cathode electrode 2 | Anode electrode 1 | 0.465 |
| Cathode electrode 3 | Anode electrode 3 | 0.47 |
| Cathode electrode 3 | Anode electrode 4 | 0.465 |
| Comp. Ex. 3 | Comp. Ex. 4 | 0.49 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A supported catalyst for a fuel cell electrode comprising a carrier and a catalytic metal supported on the carrier, the carrier comprising a hydrophilic metal oxide A, the carrier further comprising a metal oxide B being supported on at least a part of the surface of said carrier to impart proton conductivity to the supported catalyst.

2. The supported catalyst according to claim 1, wherein the metal oxide B comprises an oxide containing at least one element selected from the group consisting of tungsten (W), molybdenum (Mo), vanadium (V), and boron (B).

3. The supported catalyst according to claim 1, wherein the hydrophilic metal oxide A is titanium oxide TiOₓ or zirconia oxide ZrOₓ, and the catalytic metal comprises platinum particles or particles of an alloy of at least one element selected from platinum group elements and fourth to sixth period transition metals with platinum.

4. The supported catalyst according to claim 1, wherein the amount of the catalytic metal supported is 10 to 80% by weight, and the content of the metal oxide is 0.1 to 20% by weight.

5. The supported catalyst according to claim 1, wherein the metal oxide B which accelerates proton conduction is a solid oxide superstrong acid having a Hammett acidity function H₀ of −20.00<H₀<−11.93.

6. An electrode for a fuel cell comprising a supported catalyst according to claim 1, an electroconductive material and a binder.

7. A membrane electrode assembly comprising an electrode according to claim 6.

8. A fuel cell comprising a membrane electrode assembly according to claim 7.

9. A process for producing a supported catalyst according to claim 1, comprising:
supporting a metal salt as a precursor of a catalytic metal on a carrier comprising a hydrophilic metal oxide A to prepare a first composite;
subjecting the first composite to reduction treatment to support the resultant catalytic metal onto a surface of the carrier to obtain a second composite;
supporting a precursor of a metal oxide B onto the second composite to obtain a third composite; and
subjecting the third composite to heat decomposition treatment to produce a supported catalyst having proton conductivity.

10. The process according to claim 9, wherein the metal oxide B comprises an oxide containing at least one element selected from the group consisting of tungsten (W), molybdenum (Mo), vanadium (V), and boron (B).

11. The process according to claim 9, wherein the hydrophilic metal oxide A is titanium oxide TiOₓ or zirconia oxide ZrOₓ, and the catalytic metal constituting the catalyst component comprises platinum particles or particles of an alloy of at least one element selected from platinum group elements and fourth to sixth period transition metals with platinum.

12. The process according to claim 9, wherein the amount of the catalytic metal supported is 10 to 80% by weight, and the content of the metal oxide is 0.1 to 20% by weight.

13. The process according to claim 9, wherein the metal oxide B is a solid oxide superstrong acid having a Hammett acidity function H₀ of −20.00<H₀<−11.93.

14. The process according to claim 9, wherein said reduction treatment is carried out at an elevated temperature by use of a furnace.

15. The process according to claim 14, wherein said reduction treatment is carried out in the range of from 100° C. to 900° C.

16. The process according to claim 14, wherein said reduction treatment is carried out in the range of from 200° C. to 500° C.
